(19) United States
(12) Patent Application Publication
(10) Pub. No.: US 2012/0170003 A1
(43) Pub. Date: Jul. 5, 2012

(54) Color Image Projector

(76) Inventor: Kuo-Ching CHIANG, New Taipei City (TW)

(21) Appl. No.: 13/342,509

(22) Filed: Jan. 3, 2012

(30) Foreign Application Priority Data
Jan. 3, 2011 (TW) 099147435
Jun. 30, 2011 (TW) 100123171

(51) Int. Cl. G03B 21/14

(52) U.S. Cl. 353/31

(57) ABSTRACT

A color image projector includes a sequence light color control module; a light guiding structure; a plurality of mono-light sources coupled to the color-light control unit for emitting light of the plurality of mono-light sources in sequence, and wherein the plurality of mono-light sources located at three sides of the light guiding structure; a gray scale display correspondingly configured to a fourth side of the light guiding structure and for displaying gray scale image, and whereby forming red, green, blue images in sequence by the plurality of single-color light sources; and a projection lens correspondingly configured to the display for projecting the red, reen, and blue images sequentially, whereby forming color images by visible persistence.

### CROSS-REFERENCE TO RELATED APPLICATION

This present application claims priority to TAIWAN Patent Application Serial Number 099147435 and 100123171, filed on Jan. 3, 2011 and Jun. 30, 2011 respectively, which are herein incorporated by reference.

### TECHNICAL FIELD

The present invention generally relates to a mini projector, and especially to an image projector with multiple light sources and single display.

### DESCRIPTION OF THE RELATED ART

In pace with the development of information and computer technology, electronic products grow rapidly in trend of small size, multifunction and high operation rate. Based on the incoming era of high technology, telecommunication network and internet becomes a rising industry currently. Following by progress of mobile phone integration technology, communication systems have also been introduced to provide users to obtain information more conveniently. Thus, the communication technology turns to be an important role in the industry, and the communication device business flourishes rapidly due to the essential requirements of communication and the convenience of fetching information. Therefore, Internet, cellular, and PDAs (personal digital assistant) have flooded in the daily life. The internet and communication providers also supply various business services to assist clients to transmit or receive information for extending the market and the coverage of services. And the electronic components tend to become small size, multifunction, and high speed. The communication services providers or the information services providers also have to provide diverse, comprehensive and updated information to the clients. Current portable communication devices commonly used include mobile phones, stock display devices, and PDAs, and these are gradually popular in ordinary life and become indispensable electronic products. Additionally, systems for integrating aforementioned electronic devices also become popular in daily life.

Most projectors presently used employ single light source and multiple LCDs, and images can be magnified through projection lens. But, this structure needs beam splitters and reflector mirrors to split light beams, which is too complicated and can not be minified. In another aspect, DMD chip is also used in the DLP system, however, the cost will be raised and a color wheel is required, and mechanical vibration will occur more easily. In the other aspect, the color separation circuit is also employed in other type of prior art, and nevertheless, it has to separate one color image to three images with different color objects and provides the color object with the same color light, followed by synthesizing those different colors objects subsequently. Thus, the projection means are not only too complicated, but also the color separation circuit is required.

One example of prior art is shown in FIG. 1. In the figure, light emitted from the light source 700 is guided to the LCOS (Liquid crystal on Silicon) 720 through the polarization beam splitter 710. After light passing through liquid crystals, it will be reflected back through the polarization beam splitter 710, and will be projected sequentially by the lens 730. Because almost 50% of polarized light is filter out by the polarization beam splitter 710 and the residual light intensity and the energy are partially absorbed or consumed by the LCOS, such that the luminosity will be insufficient. Further, the optical path is too long.

Recent projector is quite bulky, heavy, and not easy to be taken alone, and it also generates heat with high temperature and efficiency of the conventional projector is low, thus, the typical projector has lots of shortcomings. Referred to FIG. 2, which exhibits optical path in the traditional projector, a white light source 22 is introduced, and light emitted from the white light source 22 can pass through the lens kit 24. Two colors of light can be filtered by light filter 30 and then reflected by the reflection lens 38 into the prism, and rest colors of light can be guided into the prism through the optical devices 34 and 36, and finally, colors of light will be guided into the prism through three colors display elements 28 to be combined, and the combined image will be projected through the projection lens 26 sequentially. Additionally, aforementioned projector requires the relay lens 40 to 42. The optical system of the projector disclosed above utilizes three filters to separate white light into red, green, and blue light, and the RGB images can be combined in the prism after passing through the displays. Since the complicated optical system comprises lots of filters, and reflectors, etc, the size of the projector cannot be minified.

### SUMMARY

Based on aforementioned description, the purpose of the present invention is to provide an image projector with plural light sources and single display.

A color image projector includes a sequence light color control module; a light guiding structure; a plurality of mono-light sources coupled to the color-light control unit for emitting light of the plurality of mono-light sources in sequence, and wherein the plurality of mono-light sources located at three sides of the light guiding structure; a gray scale display correspondingly configured to a fourth side of the light guiding structure and for displaying gray scale image, and whereby forming red, green, blue images in sequence by the plurality of single-color light sources; and a projection lens correspondingly configured to the display for projecting the red, reen, and blue images sequentially, whereby forming color images by visible persistence.

The light guiding structure includes, X-plate, X-cube or dichroic mirror. The plurality of mono-light sources comprise laser, LED, or organic electro-luminescence device. The gray scale display includes LCD, PDP (plasma display panel), organic light-emitting display, electroluminance display, or field emission display. The pluralities of mono-light sources comprise red, green, blue light sources, or red, green, blue, white light sources. The image projector is built in or plug-in externally to a portable device, and the portable device includes a cell phone, a notebook, a media player, digital camera, digital recorder, tablet or a GPS. A Fresnel lens or a collimator is configured between the plurality of mono-light sources and the gray scale display.

The sequence light color control module coupled to the plurality of mono-light sources for switching plurality of mono-light sources to emit different color light with sequence, wherein switching-on time of two of the at least three independent lights is selected from the group consisting of: (1) non-overlap, (2) over-lapped with fifty percentage, (3) over-lapped higher than the fifty percentage, and (4) lower than the fifty percentage. The color image projector further comprises a wireless transferring module that is compatible to the WiFi, 802.11 standard (802.11a, 802.11b, 802.11g, 802.11n), Bluetooth standard or WiMax.

A color image projector includes a light guiding structure; a plurality of white-light sources for emitting light, and wherein the plurality of white light sources located at three sides of the light guiding structure; a color display correspondingly configured to a fourth side of the light guiding structure and for displaying color image; and a projection lens correspondingly configured to the display for projecting images. The light guiding structure includes, X-plate, X-cube or dichroic mirror. The pluralities of white light sources comprise laser, LED, or organic electro-luminescence device. The color display includes LCD, PDP (plasma display panel), organic light-emitting display, electroluminance display, or field emission display. The color image projector is built in or plug-in externally to a portable device, and the portable device includes a cell phone, a notebook, a media player, digital camera, digital recorder, tablet or a GPS. The color image projector further comprises a Fresnel lens or a collimator configured between the plurality of white light sources and the color display. The light control module coupled to the plurality of white light sources for switching plurality of white light sources to emit different color light with sequence, wherein switching-on time of two of the at least three independent lights is selected from the group consisting of: (1) non-overlap, (2) over-lapped with fifty percentage, (3) over-lapped higher than the fifty percentage, and (4) lower than the fifty percentage. The color image projector further comprises a wireless transferring module that is compatible to the WiFi, 802.11 standard (802.11a, 802.11b, 802.11g, 802.11n), Bluetooth standard or WiMax.

### BRIEF DESCRIPTION OF THE DRAWINGS

FIG. 1 shows the prior art.

FIG. 2 shows the prior art.

FIG. 3 shows a functional diagram of the projector of the present invention.

FIG. 3A-3B illustrates a light source of the projector

FIG. 4-4A exhibits a functional diagram of the projector of the present invention.

FIG. 5 shows the embodiment of the present invention.

FIG. 6-6D shows the lens embodiment of the present invention.

FIG. 7A-7E illustrates the timing control of the present invention.

### DETAILED DESCRIPTION

For making readers further understand aforementioned and other purposes, features, and advantages, some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

The present invention can also be built in or plug-in externally to a portable communication device which includes a cellular, a PDA, note book, tablet, or a smart phone. A portable wireless communication device generally includes a cellular, a PDA, or the like. The system of aforementioned wireless communication device generally comprises a wireless communication module, which is compatible with protocol of bidirectional transmission, and the cellular and the PDA comprises at least one bidirectional communication module. In regard to the bidirectional communication module, the adapted protocol is, for instance, GSM, CDMA, PHS, or the communication protocols of bidirectional communication device. Messages provided by service suppliers can be received by the bidirectional communication module, and can be decoded by a decoder, whereby being converted to recognizable signals. The wireless communication device comprises a microprocessor or a CPU, and a user interface coupled to the microprocessor for facilitating input of commands. The commands can be input by touch or voice control. Signals received by bidirectional communication module can be output by the microprocessor and stored in the data or program of the memory unit for being processed, such as checking communication protocol, reading or determining the signals.

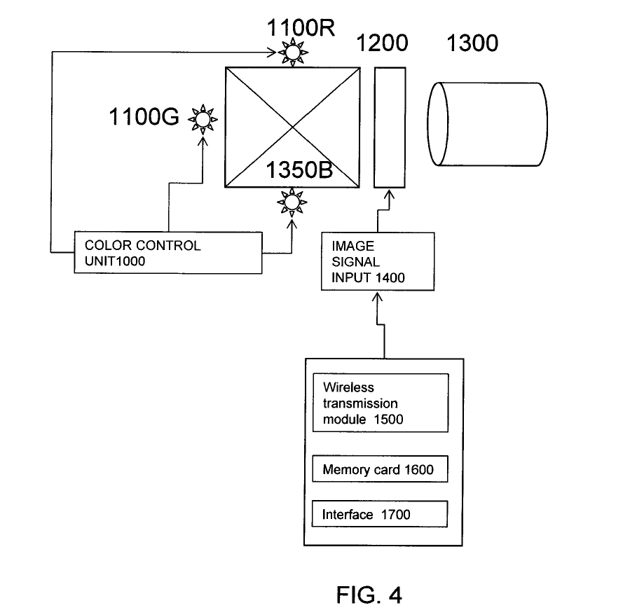

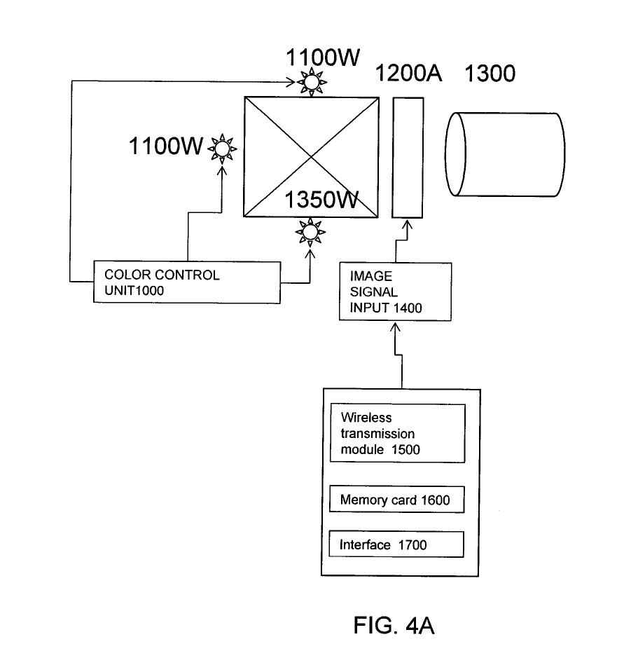

FIG. 3 and FIG. 4 illustrate the image projector with plural light sources and single display, which comprises a color-light control unit 1000. In an embodiment, a single display 1200 is provided for displaying grey scale images. And those images can be magnified and projected on a screen or wall by the projection lens 1300. Aforementioned display 1200 may includes LCD (HTPS, LTPS), organic light-emitting display, field emission display, etc. Multiple mono-light sources 1100 emit at least three kinds of mono-light for emitting blue, green, and red light respectively, thereby facilitating to combine the color image. The image in single display panel can appeared as grey scale, and it can be penetrated by the corresponding light, such as red, green, and blue light 1100R-1100G-1100B, which are emitted respectively, and finally, the image penetrated by corresponding light can be magnified and projected by the projection lens 1300. The emitting order of aforementioned three kinds of mono-light can be arranged randomly, such as BGR (blue, green, red), BRG, GRB, GBR, BRG, or BGR, etc. Because three colors are emitted successively, people can see color images due to visual persistence phenomena. Luminous intensity and emitting time of every color from multiple mono-light sources 1100 can be controlled based on the color information by the color-light control unit 1000. A light guiding structure 1350 is arranged and those red, green, and blue light 1100R-1100G-1100B is set at adjacent to the three sides of the light guiding structure 1350 and the lights emit illumination on sequent and through the light guiding structure 1350 which alter the optic direction to allow the light to toward to the single panel. The optical path of each light sources, red, green, and blue light 1100R-1100G-1100B to the display panel 1200 are identical due to the present of the light guiding structure 1350. The candidates of the light guiding structure 1350 maybe a X-plate, X-cube or dichroic mirror.

For improving luminous intensity and preventing the dark light issue, the multiple mono-light sources 1100 can further emit white light in addition to aforementioned three colors, so as to enhance luminous intensity. The white light can be inserted in any arrangements of aforementioned three colors. Images generated by the display 1200 are fed by the image signals input unit 1400. Because the present invention emits at least three kinds of mono-light and sequentially projects a red image, a green image, and a blue image to the screen by a grey scale display, the color separation device is not required and the image has not to be split, therefore, the light beam splitter is not required any more. If LED, laser, or EL (electroluminescence) elements, etc is chosen, the device can be not only minimized, but also achieve heat dissipation efficiency higher than the bulb.

Simply speaking, emitting order and luminous intensity of each independent mono-light can be controlled by the color-light control unit, thereby mixing the three independent images into color image by visual persistence of human eyes based on the three color light beams are emitted in sequence within the duration of the visual persistence. When mono-light passes through the display 1200, the grey scale image on the display 1200 will become mono-color image such as red, green or blue image, and afterward, each mono-color image will be projected by the projection lens 1300, followed by being mixed into a color image due to the visual persistence of human eyes. Hence, the present invention employs plural mono-light sources which generate not much heat.

Further, the present invention introduces a single display. Three images with different colors can be generated in different time because each mono-light emits through the single display in success. Then, those images can be projected on the screen by the projection lens, independently. Therefore, the advantage of the present invention is that a plurality of displays are not required, thereby reducing the cost and simplifying the structure. Furthermore, the light beam splitter for splitting light is not required any more, and the prism for combining split light is not desired either. Consequently, the present invention simplifies the optical structure significantly. Moreover, the color separation device for separating colors of a frame is also not required. In a preferred embodiment, the display 1200 comprises LCD for rendering grey scale images. When grey scale images are employed, the LCD doesn't need any color filter. Because color filters shade light greatly, which make luminosity insufficient, if the color filters can be eliminated, it will be helpful for minimizing the structure, improving luminosity and reducing power consumption.

Aforementioned emitting light source can employ organic light-emitting elements, which emits red, green, and blue light. Pluralities of light sources maybe employed and arranged as shown in FIG. 3A. Light sources may be formed as a light array as shown in FIG. 3B. White light and/or yellow light maybe introduced into the light array. The projection lens 1300 is configured at the side of the display, and a screen can be placed at a proper position for receiving the projected images. Thus data, files, or games stored in the communication device, the media player, or the computer memory can be magnified and projected to external. Because the present invention utilizes thin and small elements such as organic light-emitting elements, light emission elements, or laser, etc, it can be integrated in the cell phone, digital camera, digital image recorder or GPS. The wireless transmission module 1500 can received images from external, and the images or signals desired to be projected can be input by the image signal input unit 1400. Images or signals desired to be projected can also be input through a memory card or a flash drive 1600, such that inconvenience raised by carrying the computer can be alleviated. Those images or signals can also be input through the input interface 1700, such as the cell phone with USB, or HDMI, thereby projecting images or information in the cell phone. FIG. 4A is another example, the display panel is a color display panel 1200 A instead of gray scale display panel. The light sources are all white light sources 1100W.

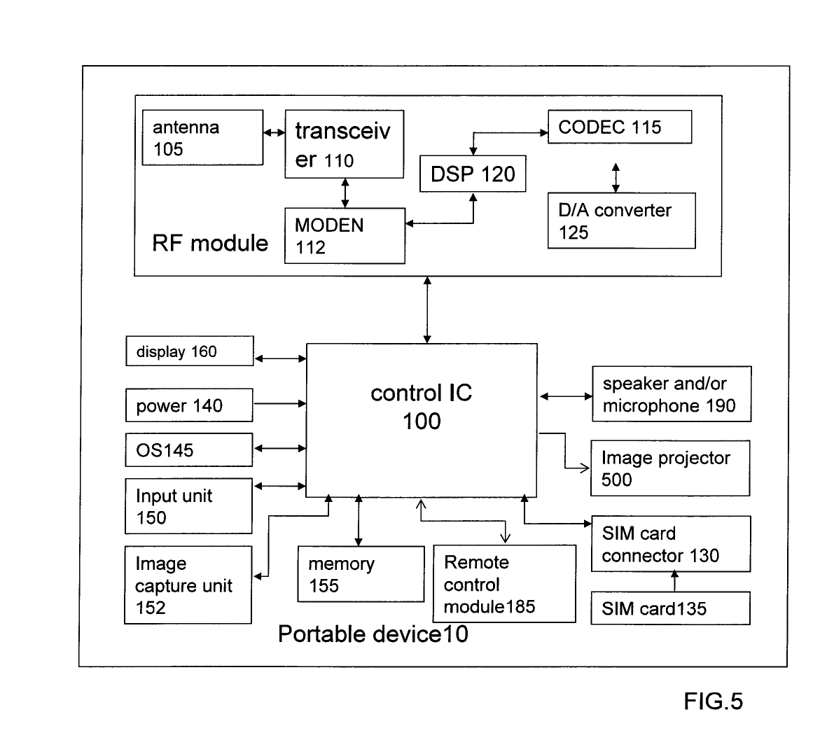

FIG. 5 shows a block diagram of the present invention integrated in a cell phone or tablet. It comprises a SIM card connector 130 to carry the SIM card 135 if the device is cellular or smart phone. The SIM card is not necessary for some other type of cellular such as PHS system. The portable communication device 10 includes a RF module. The RF module includes antenna 105. This antenna 105 is connected to a transceiver 110, which is used to receive and transmit signal. The RF module further includes CODEC 115, DSP 120 and A/D converter as well. The present invention includes a central control IC 100 for controlling process of signals, data, power and input or output. An input unit 150, a built-in display 160, OS 145, and power 140 are coupled to the control IC 100 respectively. The OS may be MS, Apple OS or Android.

The present invention further comprises memory 155 coupled to the control IC 100 for storing data and OS. The memory 155 may include ROM, RAM and nonvolatile FLASH memory, etc, depending on different properties. The RF module may perform the function of signal transmitting and receiving, frequency synthesizing, and digital signal processing. The SIM card hardware interface is used for receiving a SIM card. Finally, the signal is send to the final actuators such as a speaker and a microphone 190. Memory unit can be divided to three parts, which include MASK ROM, nonvolatile memory such as FLASH and SRAM. Generally speaking, fixed data can be stored in MASK ROM, and the system operation software or fixed application program can be generally stored in nonvolatile memory and execute other commands, the nonvolatile memory can still remain data inside when it's out of power, and can be read and wrote repeatedly when power is available. The image capture unit 152 is coupled to the control IC 100.

Another feature is that the present invention further includes a remote control module 185 coupled to the control IC 100 for controlling locks or the electronic devices by the keys or control codes stored in the memory 155. The remote control technology is well known in the art. For example, the remote control module 185 can transmit control signals via IR (infrared ray), internet, or telecommunication network. The control codes, or keys can be downloaded from the service supplier through the communication module of the cell phone, and can be stored in the memory 155. The communication module of the cell phone can transmit control signals, too. Besides, IR of remote control module 185 can also be applied on data transmission in short range. The originality of the present invention is to integrate various electronic devices for benefiting to take it alone and applying it on various situations, thereby improving the convenience. Further, the present invention can share some elements or devices to be integrated. Therefore, aside from communication, the cell phone of the present invention can further project images, be controlled remotely, and be applied on a conference. The present invention includes one or more modules which is/are all not disclosed in any current portable communication device. It is noted that the present invention can be implanted one or more module depending on demands.

The color display with transparent substrates maybe employed for the FIG. 4A for rendering color images. The first embodiment displays grey scale images, and is quite different from the present embodiment. The color images can be enlarged and projected on a screen or wall. Aforementioned display may include LCD, organic light-emitting device, field emission display, etc. The mono-light source 3100 emits white color. The images on the single LCD in the first embodiment is grey scale, followed by being penetrated respectively by three kinds of corresponding mono-light, such as red, green, and blue light. However, the present embodiment is different from the first embodiment. The embodiment employs white light to penetrate the color display, and images will be magnified and projected. Images on the display 3200 are feed by image signal input unit 3400. If Plasma display, field emission display, or organic light emitting display is introduced, florescence powders can be employed to appear grey scale or colors to take place of color filters, thereby raising luminosity.

Therefore, the advantage of the present invention is not requiring a plurality of RGB respective displays, thereby simplifying the circuit structure. Further, the present invention doesn't need a light beam splitter for splitting light from light source, and further doesn't need any prism for combining split light either. Thus, the present invention can simplify the optical structure significantly. Moreover, the color separation device for separating colors of a frame is also not required. A transparent substrate is provided and transparent electrodes are formed on the glass substrate (such as glass, quartz, or acrylate etc). The transparent electrodes may be made of indium tin oxide (ITO) and may be used as the emitter electrodes. Stacked gate that covers a portion of the transparent electrodes is formed on the glass substrate. Emitters that emit electrons are formed on a portion of the transparent electrode. Each stacked gate includes a mask layer for covering a portion of the transparent electrodes, and is formed by UV photolithograph mask. The mask layer is preferably transparent to visible light, but opaque to ultra violet rays and can be made of an amorphous silicon layer. The silicon layer will be transparent when the thickness is thin enough. A stacked gate structure includes first insulating layer/a gate electrode/a second insulating layer/focus gate electrode, sequentially formed over the substrate. The gate insulating layer is preferably a silicon oxide thin film with a thickness of 2 μm or more and the gate electrode is made of chrome with a thickness of about 0.25 μm. The gate electrode is used for extracting an electron beam from the emitter. The focus gate electrode performs as a collector for collecting electrons emitted from emitter so that the electrons can reach a fluorescent film disposed above the emitter. If the device is used for display, the substrate can be silicon or transparent substrate. A front panel is disposed upward and above the stacked gate. A variety of visual images are displayed on the front panel. A fluorescent film is attached to a bottom surface of the front panel that faces the stacked gate and a direct current voltage is applied to the fluorescent film to emit color for display. The fluorescent substance may emit color light by mixing the emitted light if the thin film comprises R, G, B fluorescent substances. Preferably, the present invention includes three such emission displays that separately display image in red components, green components, and blue component (namely, red, green and blue images). The fluorescent substances emit red, green, and blue visible light when excited by the electron beam, and the light can be evenly distributed on the fluorescent film. Spacer separating the front panel from the stacked gate is a black matrix layer and is not shown for convenience. Since the thin film display is formed with thinner thickness and the power consumption is lower than LCD, the present invention may provide a smaller size, lighter weight device. The life of battery may last longer. The field emission device does not require complicated, power-consuming back lights and filters which are necessary for LCD. Moreover, the device does not require large arrays of thin film transistors, and thus, a major light source of high cost and yield problems for active matrix LCDs is eliminated. The resolution of the display can be improved by using a focus grid to collimate electrons drawn from the microtips. Preferably, the emitter includes a carbon nanotube emitter to further reducing the device size. Further, the display may omit the liquid crystal material. Furthermore, the field emission display does not require the S/D regions which are required by TFT for LCD. In another embodiment, LED source may irradiate mono color light. Namely, blue light, red light and green light LEDs are employed to act the light source. In one case, the LED may be formed in a matrix or linear configuration. Please be noted that the elements with fluorescent substances. Similarly, the light source unit can be formed by three mono-light FED (or EL) or a single FED (EL) which may emit three mono-lights. The organic light-emitting element can also be introduced, which doesn't require color filters so that the thickness can be reduced, and doesn't generate too much heat so as to minimize the device.

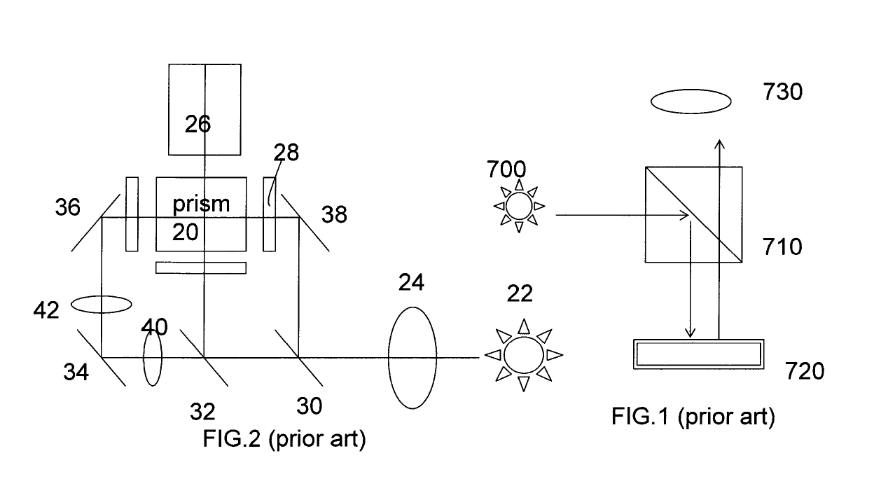

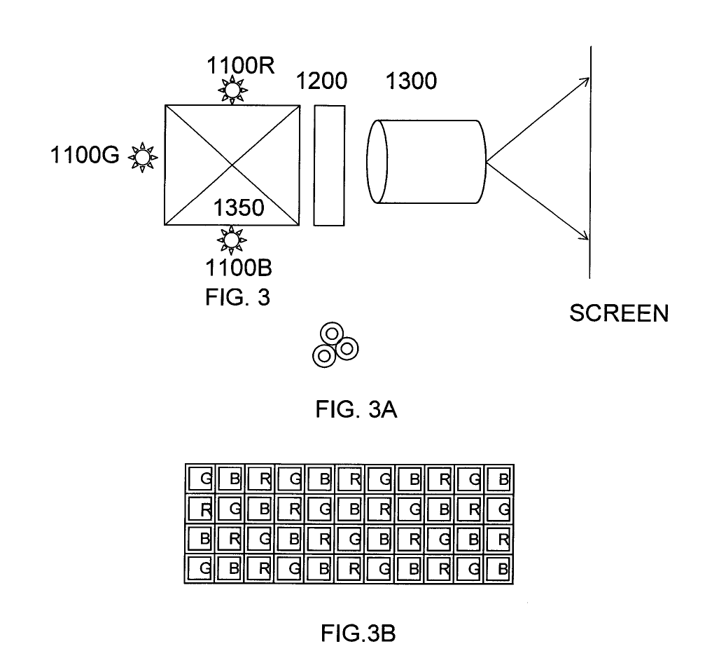

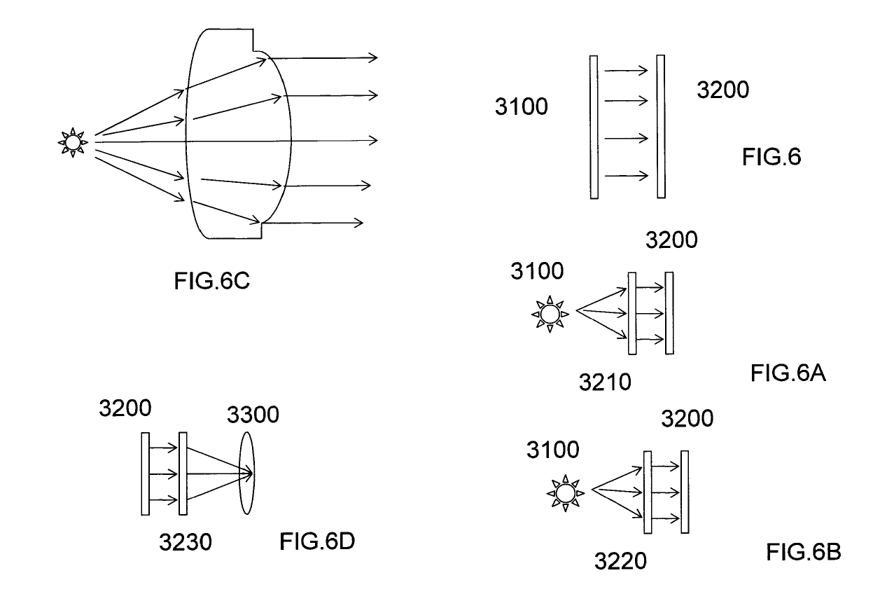

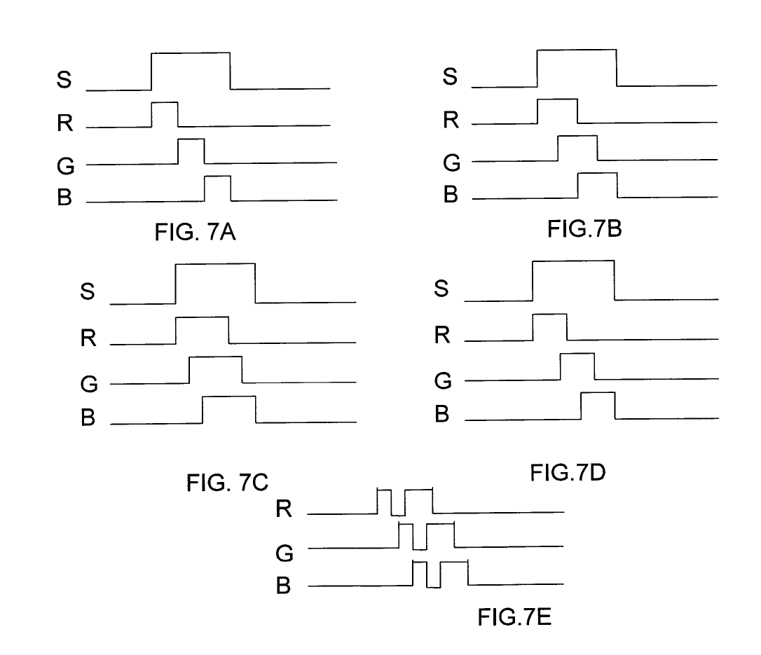

Referred to FIG. 6 A, if aforementioned planar light source is not employed, a Fresnel lens 3210 can be configured adjacent to the light source 3100. The light source 3100 is positioned at about the focus point of the Fresnel lens 3210, such that the light from light source can turns parallel through the Fresnel lens 3210. The Fresnel lens includes a curved surface cut to be discontinuous, and the curved surface has identical curvature. The curved surface is cut in tiny range, so it may look like numerous of circles. In other words, the Fresnel lens 3210 contains a plurality of concentric circles (ie, Fresnel zone) for achieving light-concentrating. Contrarily, if the light source is positioned at the focal point, a parallel light bean will be generated and will penetrate the lens. In the meantime, the Frenel lens 3210 can reduce the thickness for minimizing the device. The Fresnel lens can be regarded as a serial of prisms arranged circularly, wherein the edge is sharper, and center is smoother. The configuration of the Fresnel lens allows reducing the thickness, weight, and size of the present invention dramatically. Besides, the Fresnel lens configured in front of the light source can be applied in aforementioned embodiments, such as embodiments of FIG. 1, or FIG. 3, and is not limited to the current embodiment.

A collimator 3220 can also be introduced to replace aforementioned Fresnel lens or to cooperate with the Fresnel lens for facilitating to generate parallel light, such as shown in FIG. 6B. The collimator 3220 comprises a curved lens, and the light source is positioned at the focal point of the curved lens. The surface of the collimator 3220 that faces the light source has higher curvature, and the other surface not facing the light source has lower curvature. The collimator 3220 can also check whether other optical components are located on the optical axis, and hence, it can not only make light parallel, but also be used for correction. The collimator 3220 configured in front of the light source can further be applied in aforementioned embodiments, and is not limited to the present embodiment. Aforementioned Fresnel lens may also be configured between the display and the projection lens, wherein the projection lens is positioned at the focal lens.

In another embodiment, apart from aforementioned features, if the self-luminous color display, such as OLED, field emission display, or EL display, is employed, the light source can be omitted since the florescence layer therein can illuminate when providing current. If the luminosity is in the acceptable range, the light source can be retrenched, thereby further achieving the advantage of minimizing Compared to the LCD, the advantages include: thickness thinner than 1 mm, and lighter weight; solid structure with vibration resistance better than liquid. Moreover, it's advantageous that the structure almost has no issues about the viewing angle, so that the images would still not be distorted while being watched in a widely viewing angle. For, example, AMOLED (Active Matrix/Organic Light Emitting Diode) can be employed, because it submits higher speed, higher contrast ratio, wider viewing angle, and doesn't require any back light plate, it can be manufactured in a thinner configuration and can save more power. The AMOLED without the back light plate can save about 30-40% of the cost of the back light module in TFT LCD, referred to FIG. 6D. A Fresnel lens or collimator 3230 is configured between the projection lens 3300 and the self-luminous display 3200, and aforementioned projection lens is positioned at the focal point of the Fresnel lens or the collimator 3230.

A reflector can be configured at the backside of the light source in each embodiment mentioned above depending on demands, so as to reflect light to the display. Aforementioned collimators can be replaced by the light grating, so as to provide uniform light. Aforementioned units and modules can be combined arbitrarily according to demands.

Please refer to FIG. 10A, if the image signal is indicated by S with an image signal frequency, at least three color signals is switched during an image frame, the switching frequency is higher than the image signal frequency (rate). In the embodiments, the switching on time of the R, G, B is not overlapped one another. Namely, the turn-on time for each color is ⅓ of each image frame. After a certain playing time, each color is turn on for only ⅓ of the total playing time, thereby achieving the purpose of power saving. Please refer to FIG. 10B, in order to increase the photo number within the image frame, the switching frequency (rate) of the R, G, B is raised, in the case, the switching on time is overlapped with another color by 50% for each colors. To phrase in another way, the second color is enable when the first color is switched to half of the switching on cycle. When the first color is off and the third color is on. At any moment, there are two kind of color light is on and the third one is off to raise the luminous.

Please refer to FIG. 10C, it can be found that the turn-on time of the color lights is overlapped over 50% with each other. After half cycle of the turn-on time of the first color light, three color lights is on. The overlap time may be controlled under 50% as shown in FIG. 10D. Based on the above methodology, the overlap percentage between two color lights may be control with higher than, equal or lower than 50%, the balance between the power-saving and luminous may be achieved. The switching on time may be separated during one image signal frame as shown in FIG. 10E.

As will be understood by persons skilled in the art, the foregoing preferred embodiment of the present invention is illustrative of the present invention rather than limiting the present invention. Having described the invention in connection with a preferred embodiment, modification will now suggest itself to those skilled in the art. Thus, the invention is not to be limited to this embodiment, but rather the invention is intended to cover various modifications and similar arrangements included within the spirit and scope of the appended claims, the scope of which should be accorded the broadest interpretation so as to encompass all such modifications and similar structures. While the preferred embodiment of the invention has been illustrated and described, it will be appreciated that various changes can be made therein without departing from the spirit and scope of the invention

What is claimed is:

1. A color image projector including:
a sequence light color control module;
a light guiding structure;
a plurality of mono-light sources coupled to said color-light control unit for emitting light of said plurality of mono-light sources in sequence, and wherein said plurality of mono-light sources located at three sides of said light guiding structure;
a gray scale display correspondingly configured to a fourth side of said light guiding structure and for displaying gray scale image, and whereby forming red, green, blue images in sequence by said plurality of single-color light sources; and
a projection lens correspondingly configured to said display for projecting said red, green, and blue images sequentially, whereby forming color images by visible persistence.

2. The color image projector according to claim 1, wherein said light guiding structure includes, X-plate, X-cube or dichroic mirror.

3. The color image projector according to claim 1, wherein said plurality of mono-light sources comprise laser, LED, or organic electro-luminescence device.

4. The color image projector according to claim 1, wherein said gray scale display includes LCD, PDP (plasma display panel), organic light-emitting display, electroluminance display, or field emission display.

5. The color image projector according to claim 1, wherein said pluralities of mono-light sources comprise red, green, blue light sources, or red, green, blue, white light sources.

6. The color image projector according to claim 5, wherein said image projector is built in or plug-in externally to a portable device, and said portable device includes a cell phone, a notebook, a media player, digital camera, digital recorder, tablet or a GPS.

7. The color image projector according to claim 1, further comprising a Fresnel lens or a collimator configured between said plurality of mono-light sources and said gray scale display.

8. The color image projector according to claim 1, wherein said sequence light color control module coupled to said plurality of mono-light sources for switching plurality of mono-light sources to emit different color light with sequence, wherein switching-on time of two of said at least three independent lights is selected from the group consisting of: (1) non-overlap, (2) over-lapped with fifty percentage, (3) over-lapped higher than said fifty percentage, and (4) lower than said fifty percentage.

9. The color image projector according to claim 1, further comprising a wireless transferring module that is compatible to the WiFi, 802.11 standard (802.11a, 802.11b, 802.11g, 802.11n), Bluetooth standard or WiMax.

10. A color image projector including:
a light guiding structure;
a plurality of white-light sources for emitting light, and wherein said plurality of white light sources located at three sides of said light guiding structure;
a color display correspondingly configured to a fourth side of said light guiding structure and for displaying color image; and
a projection lens correspondingly configured to said display for projecting images.

11. The color image projector according to claim 10, wherein said light guiding structure includes, X-plate, X-cube or dichroic mirror.

12. The color image projector according to claim 10, wherein said plurality of white light sources comprise laser, LED, or organic electro-luminescence device.

13. The color image projector according to claim 10, wherein said color display includes LCD, PDP (plasma display panel), organic light-emitting display, electroluminance display, or field emission display.

14. The color image projector according to claim 10, wherein said color image projector is built in or plug-in externally to a portable device, and said portable device includes a cell phone, a notebook, a media player, digital camera, digital recorder, tablet or a GPS.

15. The color image projector according to claim 10, further comprising a Fresnel lens or a collimator configured between said plurality of white light sources and said color display.

16. The color image projector according to claim 10, wherein said light control module coupled to said plurality of white light sources for switching plurality of white light sources to emit different color light with sequence, wherein switching-on time of two of said at least three independent lights is selected from the group consisting of: (1) non-overlap, (2) over-lapped with fifty percentage, (3) over-lapped higher than said fifty percentage, and (4) lower than said fifty percentage.

17. The color image projector according to claim 10, further comprising a wireless transferring module that is compatible to the WiFi, 802.11 standard (802.11a, 802.11b, 802.11g, 802.11n), Bluetooth standard or WiMax.
